(19) United States
(12) Patent Application Publication
(10) Pub. No.: US 2016/0094820 A1
(43) Pub. Date: Mar. 31, 2016

(54) System for balancing the brightness of 2D and 3D cinema presentation

(71) Applicants: Gary D. SHARP, Beverly Hills, CA (US); David A. COLEMAN, Beverly Hills, CA (US); RealD Inc., Beverly Hills, CA (US)

(72) Inventors: Gary D. Sharp, Boulder, CO (US); David A. Coleman, Louisville, CO (US)

(21) Appl. No.: 14/891,247

(22) PCT Filed: May 14, 2014
(86) PCT No.: PCT/US2014/038011

§ 371 Date: Nov. 13, 2015

Related U.S. Application Data
(60) Provisional application No. 61/823,188, filed on May 14, 2013.

(51) Int. Cl. H04N 9/31; H04N 13/04

(52) U.S. Cl. CPC H04N 9/3182; H04N 13/0452

(57) ABSTRACT

Disclosed is a system for balancing brightness in cinema presentation. The brightness between 2D and 3D mode in cinema presentation may be substantially maintained without a substantial change in projector lamp current when switching between the two presentation modes. A dimmer can be engaged which allows the light in at least one path to be attenuated during 2D operation. The dimmer can be activated in any number of ways, including, but not limited to, mechanically, electromechanically, or electro-optically, any combination thereof, and so forth. The dimmer may be inserted in one light path and may be physically removed from the light path during 3D operation in order to maximize 3D efficiency.

### CROSS-REFERENCE TO RELATED APPLICATIONS

This application is related to and claims priority to U.S. Provisional Pat. App. No. 61/823,188, entitled “System and method for brightness balancing for cinema presentation,” filed May 14, 2013, which is herein incorporated by reference in its entirety.

### TECHNICAL FIELD

This disclosure generally relates to optical systems, and more specifically relates to optical systems for use in 2D and 3D display.

### BACKGROUND

Generally, exhibitors and theaters or cinemas display two dimensional (“2D) or three dimensional (”3D″) content. The providers of such content may employ any type of projection systems including digital cinema projectors. Digital cinema projectors have become increasingly prevalent in theatrical presentation. In an auditorium with an averaged sized screen of approximately 40 feet wide, the platform of choice may typically be a single projector delivering 3D in a time-sequential manner. An encoding mechanism such as, but not limited to, a polarization encoding mechanism or a wavelength encoding mechanism, is switched synchronously with the presentation of left/right perspective imagery by the projector, which is then decoded by passive eyewear. In a polarization-based system, the screen is internal to the shuttering mechanism, and must therefore preserve polarization.

Historically, 3D presentation has been too dim to meet 2D Digital Cinema Initiatives (DCI) brightness specifications in the approximate range of 11-17 foot Lamberts (fL) with a single projector. Accordingly, there is a desire for a single projector platform to meet brightness specifications for both 2D and 3D.

### BRIEF SUMMARY

According to a first aspect of the present disclosure, a method for balancing brightness in a projection system may include compensating for non-uniform luminance in a projection system by locating a filter in at least a first light path of the projection system. The method may compensate for non-uniform luminance by attenuating the luminance in at least a first operating mode of the projection system. The greatest amount of luminance may be attenuated at a center region of the filter and the attenuation may be primarily achieved through absorption. The first operating mode of the projection system may be a 2D projection mode and the second mode of operation of the projection system may be a 3D projection mode. Compensating for non-uniform luminance in a projection system may include selecting and adjusting a spot size on the filter based primarily on tapering the luminance of the projection system. The method may also include removing the filter from the first light path when the projection system is in a second operating mode. Attenuating the luminance may improve the brightness distribution on a screen of the projection system in the first operating mode. Additionally, the filter may be switched to allow substantially all the light to pass through the filter when the projection system is in a second operating mode.

According to another aspect of the present disclosure, a system for balancing brightness in a projection system may include a filter that compensates for non-uniform luminance in a projection system. The filter may be located in at least a first light path of a projection system in at least a first operating mode of the projection system. Also, the filter may attenuate the luminance in the at least first operating mode of the projection system. The filter may be a gradient neutral optical density filter, a passive filter, an active electrically addressed filter, or any other appropriate filter or combination of filters. Additionally, the filter may be coated with an antireflection material. The filter may be located in at least the first light path of the projection system in the at least first operating mode of the projection system and the filter may be removed from the at least first light path of the projection system in a second operating mode of the projection system. The filter may be roughly centered with respect to a projection lens of the projection system and may be tipped forward about the horizontal by the projector down-angle, such that the central ray of a projection lens may be approximately normally incident on the filter. The filter may be electro-optically switched between a 2D operating mode and a 3D operating mode. The first operating mode of the projection system may be a 2D projection mode and a second operating mode of the projection system may be a 3D projection mode. Additionally, the filter may be located on a movable mechanism that removes the filter from the light path. The filter may be the least transmissive at the center and more transmissive with increasing distance from the center of the filter.

In yet another aspect of the present disclosure, an optical system for balancing the brightness of a projection system may include a filter that may increase light transmission with increasing distance relative to the center of the filter in a first mode and may substantially maintain transmitted peak brightness in a second mode.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1 is a schematic diagram illustrating one embodiment of a cross section through the center of an auditorium for a non-canted screen;

FIG. 2 is a schematic diagram illustrating one embodiment of a normalized luminance profile measured from a projection system, in accordance with the present disclosure;

FIG. 3 is a schematic diagram illustrating one embodiment of a unit, which may include an LC device, a high durability polarizer, and a 90-degree achromatic rotator, in accordance with the present disclosure;

FIG. 4 is a schematic diagram illustrating one embodiment of a contour plot of an example DCI compliant projector illuminance uniformity, in accordance with the present disclosure;

FIG. 5 is a schematic diagram illustrating one embodiment of a geometric illuminance factor for an example theater geometry, in accordance with the present disclosure;

FIG. 6 is a schematic diagram illustrating one embodiment of the combined effects of the two illuminance contributions, in accordance with the present disclosure;

FIG. 7 is a schematic diagram illustrating one embodiment of a contour plot of the transmissivity of a mask that corrects the illuminance factors, in accordance with the present disclosure;

FIG. 8a is a schematic diagram illustrating one embodiment of a calculation of the brightness distribution in the example theater, in accordance with the present disclosure;

FIG. 8b is a schematic diagram illustrating one embodiment of a calculation of the brightness distribution in the example theater, in accordance with the present disclosure;

FIG. 9a is a schematic diagram illustrating one embodiment of the uncorrected brightness for the front left seat in an example auditorium, in accordance with the present disclosure; and

FIG. 9b is a schematic diagram illustrating the same seat location as FIG. 9a with the attenuation mask employed in FIG. 8b, in accordance with the present disclosure.

### DETAILED DESCRIPTION

According to a first aspect of the present disclosure, a method for balancing brightness in a projection system may include compensating for non-uniform luminance in a projection system by locating a filter in at least a first light path of the projection system. The method may compensate for non-uniform luminance by attenuating the luminance in at least a first operating mode of the projection system. The greatest amount of luminance may be attenuated at a center region of the filter and the attenuation may be primarily achieved through absorption. The first operating mode of the projection system may be a 2D projection mode and the second mode of operation of the projection system may be a 3D projection mode. Compensating for non-uniform luminance in a projection system may include selecting and adjusting a spot size on the filter based primarily on tapering the luminance of the projection system. The method may also include removing the filter from the first light path when the projection system is in a second operating mode. Attenuating the luminance may improve the brightness distribution on a screen of the projection system in the first operating mode. Additionally, the filter may be switched to allow substantially all the light to pass through the filter when the projection system is in a second operating mode.

According to another aspect of the present disclosure, a system for balancing brightness in a projection system may include a filter that compensates for non-uniform luminance in a projection system. The filter may be located in at least a first light path of a projection system in at least a first operating mode of the projection system. Also, the filter may attenuate the luminance in the at least first operating mode of the projection system. The filter may be a gradient neutral optical density filter, a passive filter, an active electrically addressed filter, or any other appropriate filter or combination of filters. Additionally, the filter may be coated with an antireflection material. The filter may be located in at least the first light path of the projection system in the at least first operating mode of the projection system and the filter may be removed from the at least first light path of the projection system in a second operating mode of the projection system. The filter may be roughly centered with respect to a projection lens of the projection system and may be tipped forward about the horizontal by the projector down-angle, such that the central ray of a projection lens may be approximately normally incident on the filter. The filter may be electro-optically switched between a 2D operating mode and a 3D operating mode. The first operating mode of the projection system may be a 2D projection mode and a second operating mode of the projection system may be a 3D projection mode. Additionally, the filter may be located on a movable mechanism that removes the filter from the light path. The filter may be the least transmissive at the center and more transmissive with increasing distance from the center of the filter.

In yet another aspect of the present disclosure, an optical system for balancing the brightness of a projection system may include a filter that may increase light transmission with increasing distance relative to the center of the filter in a first mode and may substantially maintain transmitted peak brightness in a second mode.

Digital cinema projectors have become pervasive in theatrical presentation. In an auditorium with an averaged sized screen, for example approximately 40 feet wide, the platform of choice is typically a single projector delivering 3D in a time-sequential manner. A polarization or wavelength encoding mechanism is switched synchronously with the presentation of left/right perspective imagery by the projector, which is then decoded by passive filtering eyewear. In a polarization-based system, the screen is internal to the shuttering mechanism, and must therefore preserve polarization.

Historically, 3D presentation has been far too dim to meet 2D Digital Cinema Initiatives (DCI) brightness specifications such as the approximate range of 11-17 fL with a single projector. One possible objective is for a single projector platform to meet DCI brightness specifications for both 2D and 3D, but there are two obstacles. First, is the challenge to achieving acceptable 3D brightness with a practically sized lamp, or any sized lamp for that matter, due to various system inefficiencies. The other is that the ratio of 3D to 2D brightness or as discussed herein, 3D-efficiency, is inherently low, making 2D presentation too bright if 3D brightness goals are achieved. A way to achieve a 3D efficiency near unity is to increase the projector lumen output when displaying 3D content. 3D efficiency near unity may be achieved when the projector lumen ratio between 3D and 2D modes is approximately one. This is typically done by increasing lamp current, or simply replacing the lamp for a 3D run. For consistent lumen output, exhibitors often select larger wattage lamps and drive them with low initial current, which leaves little or no headroom for implementing a 3D-switch.

There are techniques for achieving adequate 3D brightness, most significantly by addressing the dominant loss mechanisms that plagued early-generation 3D systems. These losses include: (1) polarization loss; (2) screen loss, and; (3) time-sharing (sequential) loss. Polarization losses can be reduced to approximately 20% using a polarization recovery technology, such as the commercially-available RealD XL system (“XL”), as generally discussed in commonly-assigned U.S. Pat. No. 7,857,455, U.S. Pat. No. 7,905,602, and U.S. patent application Ser. No. 12/118,640, all of which are herein incorporated by reference in their entireties. RealD and XL are trademarks of RealD, Inc. The “silver” screen, which provides a high gain in the approximate range of 1.8-2.2, that benefits an on-axis measurement, typically has a total integrated scatter (TIS) of 50-54%. The TIS is given by the ratio of total power re-radiated toward audience half-space to the incident power, irrespective of gain profile. Technologies have been demonstrated that provide a TIS of 90% using engineered surfaces, as generally discussed in U.S. Pat. No. 7,898,734, which is herein incorporated by reference in its entirety, allowing much higher peak gain with broader scatter profiles. Time sharing loss is inherent to a single-engine platform, and in a RealD system, this is approximately 53%.

Other incremental loss mechanisms that can be scrutinized for increased efficiency in a projection system include the port glass insertion loss, eyewear insertion loss, and color balance loss. Color balance may be considered so that a white point may be achieved on the CIE diagram that substantially meets the DCI specification. Projectors are often designed to minimize 2D color balance loss to the approximate range of 2-5%, with 3D color balance often much higher, for example, over approximately 10%. Traditional port glass has internal absorption and reflection losses, giving an aggregated loss that can exceed 15%. However, this can be reduced to approximately 2% using water white glass and broad-band AR coatings. Passive 3D eyewear generally has an insertion loss of approximately 17%, but with high quality iodine polarizer and antireflection coatings, this can be reduced to as little as approximately 7%. Color balance losses include the conversion from native white to DCI white, and the additional loss with the 3D system in place. These color balance losses can easily exceed approximately 10%. Another loss mechanism can result from cropping to account for format and geometrical issues. In short, there are many opportunities to increase luminance through scrutinizing incremental losses.

In a practical sense, a projection system can perform optimally if it is well maintained. For example, a projection system may optimally perform if lamps are well aligned and operated according to manufacturer's guidelines, and all optics remain free of dust and residue.

While there are many loss mechanisms in cinema systems that affect overall efficiency, the 3D efficiency identifies those that are specific to delivering 3D content. An equation for the η_{3D}, 3D-efficiency is given by

$${η}_{3 D} = [ {η}_{P} {η}_{E} {η}_{T} {η}_{C} ] \frac{{L}_{3 D}}{{L}_{2 D}}$$

where, η_{P} is the transmission of the 3D encoding hardware at the projector, for example the RealD XL system, η_{E} is the transmission of the decoding eyewear, η_{T} is the time-sharing efficiency due to shuttering, η_{C} is the ratio of 3D to 2D color-balance efficiency, and the final term is the projector lumen ratio between 3D and 2D modes, which may be unity if there is no 3D-switch. The above assumes that the XL system is removed from the light path during 2D operation. Based on the numbers given above, a typical value for an XL-based system is

$${η}_{3 D} = 0.28 \frac{{L}_{3 D}}{{L}_{2 D}}$$

indicating that the 2D mode of operation may attenuate the light level by about 3.5× to achieve approximately unity 3D-efficiency. The XL system is used for purposes of description only and not of limitation as any 3D system, including the XL system, may be used with the embodiments described herein.

According to the present disclosure, it may be preferable for the XL hardware to remain in place during 2D presentation, which can increase the above coefficient to 0.35. In addition, a dimmer can be engaged which allows the light in at least one path to be attenuated during 2D operation. The dimmer can be activated in any number of ways, including, but not limited to, mechanically, electromechanically, or electro-optically, any combination thereof, and so forth. In one embodiment, the dimmer may be inserted in one path of the XL and may be physically removed from the light path during 3D operation in order to maximize 3D efficiency.

If a mechanical shutter were introduced into one path of the XL unit during 2D operation, the 3D-efficiency could be 70%, allowing DCI compliant 2D and 3D output with little to no change in lamp current. In one embodiment, this may be achieved by using a hinged opaque element to substantially or even fully extinguish light from one path so that the light along this path may not reach the screen. This may equivalently be implemented by placing the attenuating unit on either a slider, or using a roll-up configuration. An aspect of this system is that the dimmer need not fully extinguish the light, and in fact, can be used to create a more pleasing 2D experience.

Generally, 3D systems may employ gain screens to deliver high brightness. For instance, a 4k DLP projector with a 3kW lamp operating at 75% current, illuminating a 40 foot screen, can deliver up to 10 fL using XL technology, provided that the screen peak-gain is G≧2.6. Such a screen is feasible today, using an approximately 90% TIS surface, with a half-gain-angle (HGA) exceeding approximately 30°. Even higher luminance values are achievable (or equivalent luminance on larger screens) by adhering to current de-facto standards for HGA, for example, approximately 22°. However, many in the industry feel that 2D presentation should maintain greater than approximately 50% of center brightness in the corners, which includes the angular decay in screen illuminance due to various mechanisms. Broadening the HGA generally improves the image luminance uniformity, but it is often not practical because 3D systems are light-starved.

Another aspect of the present disclosure is the use of a gradient neutral density optical filter, which can substantially or fully compensate for any fall-off in illuminance, while partially compensating for fall-off due to the screen gain profile. The latter cannot be fully compensated, since the position of peak brightness primarily depends upon viewing location. The filter has greatest attenuation at the center of the screen, reducing luminance of the 2D image, and thus acting as a 3D-switch. But the transmission increases with increasing position relative to center, such that the filter somewhat compensates for fall-off in screen efficiency with angle. The filter can thus decouple 3D and 2D brightness uniformity, in principle allowing a quasi-Lambertian-2D appearance, while substantially maintaining the high peak brightness of the 3D image.

A similar compensation can in principle be introduced by the projector by superimposing a gradient attenuation function on the image data, at the expense of a loss in bit depth. According to the present disclosure, the full bit depth of the DLP chip may be preserved.

A gradient neutral density filter at the projector is a correction, and may not be equivalent to a change in the screen gain profile. The filter can determine the spatial distribution of screen illuminance, which is substantially fixed by the filter optical density profile and the filter position/orientation relative to the projector output. Corrections for improper illuminance benefit all audience members. However, the observed brightness uniformity is in general a function of viewing location. So in general, a correction for luminance may be theoretically optimum for a single viewing location. The filter can therefore be designed and positioned to be optimum for a single “ideal viewer”, with the expectation that the benefits of the correction are enjoyed to some degree by most viewers.

The projector can be approximated by a point source of approximately uniform intensity (W/sr). An angular intensity fall-off from center to corners of approximately 10% is typical, which is allowed by DCI. The local illuminance (or lumen power-density) of the screen may primarily depend upon geometrical factors, in accordance with inverse-square/cosine dependence. In the projection leg, geometrical factors include the projector vertical offset, which primarily determines the projection down-angle, and the throw ratio (in which the throw ratio is the ratio of screen width to projection distance). The screen may also be canted slightly. Screen curvature affects the incidence angle with respect to the screen normal direction. For a constant intensity source, there is a horizontal band over which illuminance is constant when the screen is curved about the vertical (with radius similar or equal to the throw distance). For a flat screen, the illuminance peaks at a single point or small area. Projectors are often situated at a significant percentage of a half-screen offset, which can make the positions of lowest illuminance at or in the area of the lower corners of the screen.

The luminance of the screen is related to the observed brightness. Luminance and illuminance are related through the bi-directional reflectance distribution function (BRDF), which can be considered a generalization of reflectivity. Low gain matte screens are often approximated as Lambertian scatterers. The BRDF of a Lambertian surface is a constant; independent of geometry. However, most front-projection screens, and polarization preserving screens in particular, tend to have gain, and may depend upon both the illumination and observation directions relative to the surface normal. Most cinema gain screens are non-directional, so the peak in the BRDF occurs along the specular reflection direction. The screen location of peak BRDF may be typically associated with the “hot-spot” of a high gain screen.

Generally, each illuminated point on any screen distributes a portion of light to all observation points. The luminance for each observed point of the screen, closely related to the sensation of brightness, may in general vary in a manner that primarily depends upon the illuminance and the screen BRDF. Because the geometry is different for each viewing location, spatially dependent (gradient) filtration introduced at the projector can provide arbitrary luminance distribution for a single observation point.

To the extent that the projector, screen, and seating are roughly centered horizontally in the auditorium, the filter may be also roughly centered horizontally for optimum results. The filter may be tipped forward (about the horizontal) by the projector down-angle, such that the central light ray may be approximately normally incident on the filter. However, if the filter is not antireflection coated, it may become necessary to tip the filter at a different angle so that reflected light does not reflect back to the projection lens. The vertical position of the filter may primarily determine which seat location may have optimal brightness uniformity.

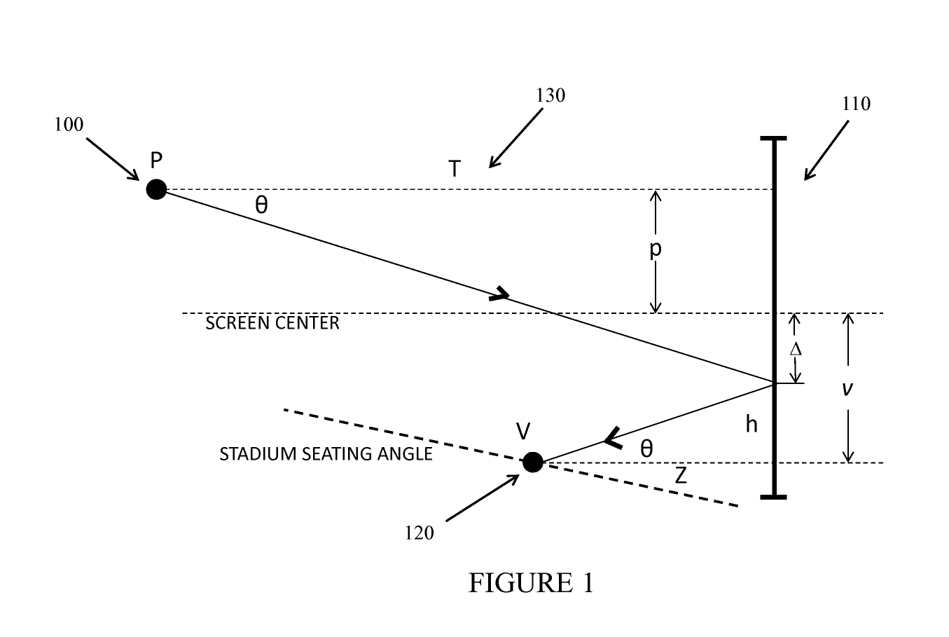

FIG. 1 is a schematic diagram illustrating one embodiment of a cross section through the center of an auditorium for a typical non-canted screen. FIG. 1 illustrates a projector 100 located at a height p, a screen 110, a viewer 120 and a throw distance 130. The projector 100 is located at a height p above screen center, at a throw distance 130, T. The viewer 120 denoted as V in FIG. 1, is at a horizontal distance Z from the screen, observing the screen from a height v below screen center. The screen position for specular reflection corresponds to the angle θ, formed between the local screen normal and the illumination/observation rays. That is, illumination and observation rays are connected via the population of reflective “facets” that lie in the screen substrate plane.

Without a filter in place, the viewer may observe the hot spot at a height of

$$h = \frac{η ( v + p )}{1 + η}$$

relative to eye level, where η is the viewing distance as a fraction of the throw distance

(η=Z/T)

The above position, h, does not in general correspond to the center of the screen. The difference in height between the hot spot location and screen center location is given by

$$Δ = \frac{v - η p}{1 + η}$$

If, for instance, Δ=0 for the ideal viewer (or, v=ηp), the hot spot is located at the approximate screen center. The gradient attenuation neutral density optical filter may then be approximately centered vertically on the projector output, such that the ideal viewer observes maximum attenuation at this location.

While the filter may not be located in an image plane, there may be some correspondence between ray position on the filter and that on the screen. It is reasonable to define a scale factor (or magnification) that roughly relates filter and screen corresponding locations. This is given by the ratio of screen height to the height of the light patch on the filter. Note that the filter height should be sized large enough to accommodate any need to adjust the filter vertically to optimize the peak attenuation. If the height of the light patch on the filter is represented by L, and the screen height is A, an estimate for the physical height adjustment of the filter is

$$l = \frac{L Δ}{A}$$

Since the projection angle is fixed, the hot-spot position may remain fixed if the viewer moves along the specular observation ray. This may be impractical because stadium seating has the opposite slope. Generally, the hot spot location drops as the viewer moves toward the screen. Additionally, the hot spot location rises as the viewer moves away from the screen. If the filter provides optimum luminance uniformity for a centrally located viewer (for example, a screen-height away), viewers near the back of the auditorium, and in particular viewers near the screen, will observe some luminance non-uniformity. The objective is to identify a filter design in which viewers at extreme locations will have a no-worse experience, while a large cluster of viewers near the ideal viewer will enjoy a much improved brightness uniformity.

The gradient attenuation neutral density optical filter can be fabricated using a number of technologies/methods, but the technology may be substantially matched to the functional requirements, to insure that the quality of the 2D image is not substantially compromised. In the example that the filter is placed in one path of a polarization recovery system, such as a RealD XL system, it is important that the transmitted wave-front distortion (TWD) is well maintained in order to substantially preserve accurate pixel overlay on the screen. Moreover, the functional material may provide the attenuation primarily through absorption, since reflection and scatter can degrade ANSI contrast. The absorbing material may be highly light stable and thermally stable, as illuminance levels at the projector can be fairly high. The filter may not reside in an image plane, so some fine non-uniformity, or gray level quantization in the attenuation profile may be likely acceptable.

As discussed above, the filter attenuation or optical density (OD) profile can be derived for the ideal-viewer based primarily on considerations of illuminance and screen BRDF. One method for doing this is to use an instrument such as a Radiant Imaging camera that provides luminance profiles at a particular auditorium location. The filter OD profile can then be derived to map the measured luminance profile onto a desired luminance profile. This can in principle be complete, though the resulting profile may be tested against other viewing locations to verify that adequate performance may be achieved. As discussed above, the hot-spot may wander with viewing location, so actual optimization may involve a convolution of the ideal-viewer profile with a function that accounts for this aspect.

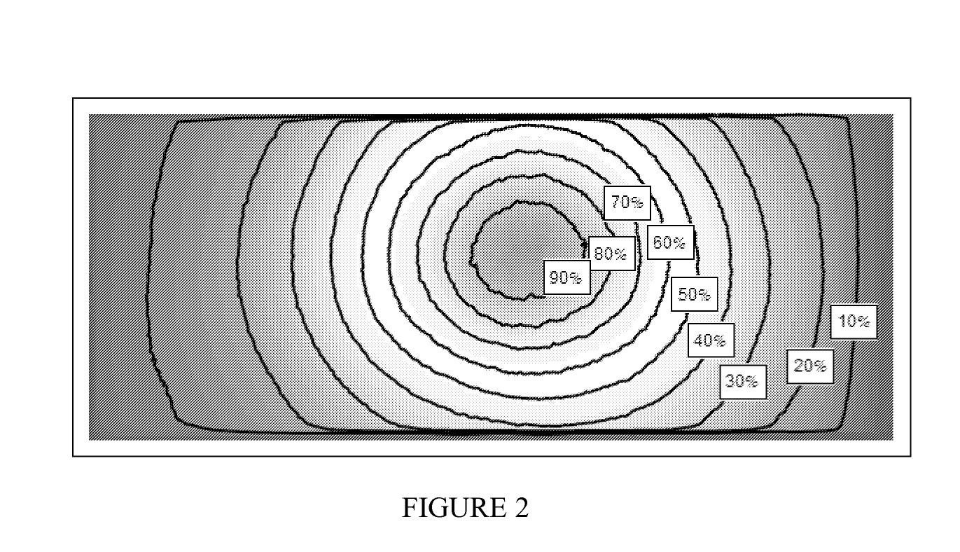

FIG. 2 is a schematic diagram illustrating one embodiment of a normalized luminance profile measured from a projection system. Further, FIG. 2 shows an example of a normalized luminance profile measured from a projection system using a flat high-gain polarization preserving screen with a 21-degree half angle using a Radiant Imaging camera. The luminance drops to below approximately 10% of peak in the corners, so it may be likely that the position of zero-attenuation is significantly in-board from this. A completely uniform luminance profile may not be possible without severe attenuation of other screen locations, so a compromise solution may be selected. A compromise filter may balance the need for center brightness attenuation against roll-off in the corners. For instance, a 3 db or 50% attenuation in the center, decaying to approximately zero at for example, approximately ¼ of screen width, may half the luminance non-uniformity while still transmitting much of the incident light.

In some instances it may be desirable to adjust the position of the filter along the optic axis. By adjusting the spot size on the filter, a more desirable attenuation profile may be selected that best tapers the luminance.

Methods for achieving the desired OD profile are varied, and may involve printing an absorbing material, photo-patterning an absorbing material, removing for example by etching a uniformly coated absorbing material, or radiation altering the absorbance of a uniformly coated absorbing material, for example bleaching. The resulting profile may be a true gradient absorber, or it may be quantized on some level. Abrupt large-scale changes in observed brightness may be undesirable, at levels typically exceeding approximately 1-2%, so any such quantization may be sufficiently small or defocused at the screen.

The material used for light absorption may be quasi-achromatic, non-scattering, and light stable. If particulates such as carbon-black is used as the absorber, the feature size may be sufficiently small so that scattering does not substantially occur, which can reduce ANSI contrast. The feature size may be preferably smaller than approximately 100 nm. The same analysis may apply to a silver-halide or a dye-based filter.

Alternatively, the filter can be implemented with a passive retardation mask, which may spatially manipulate the state of polarization. This may then be followed by an analyzing polarizer which may produce spatially modulated transmission.

In principle, the filter can be used in any projection system to transform an existing luminance profile to a desired one. It is most applicable to scenarios in which loss of light can be tolerated in one mode of operation, but is undesirable in another mode of operation. This can be the case when switching the configuration between 2D and 3D modes, in which 2D offers a surplus of light near the center of the screen. The filter may be frequently associated with some form of switching mechanism, including, but not limited to, mechanical, electro-mechanical, electro-optical, any combination thereof, and so forth. The filter can be placed on a slider or any type of sliding mechanism, a hinge mechanism, rotating mechanism or any mechanism or device that allows the filter to be physically removed from the light path.

A passive filter can be placed in many locations within the projector or after the projection lens. It can be located within an optical stack-up, provided that the associated thermal load does not substantially impact performance, for example, by affecting stress birefringence. In an XL unit, the filter can be placed upstream or downstream of the polarizing beamsplitter, with a suitable adjustment in OD. Benefits of upstream location can include at least relaxed transmitted wavefront distortion (TWD) specifications, since the filter is common to both paths of the XL, and reduced aperture size.

In an XL unit, by locating the filter downstream of the PBS, it may be desirable to substantially preserve TDW to maintain pixel registration on the screen. A very thin piece of glass, for example double-side polished glass can have excellent TWD and is light-weight. If the functional absorbing layer does not introduce a non-uniform optical thickness, then the filter may remain somewhat uncomplicated. One method of manufacturing the filter may be to coat and process the absorber on an antireflection (AR) coated piece of glass, then direct-AR coat the absorbing layer. The latter may employ a low-temperature AR process in order to accommodate the thermal budget limitations of the absorber.

In the event that the absorbing layer introduces optical distortion, a process may be employed to improve TWD. Depending upon the characteristics of the functional material, it may be possible to planarize or polish the material after processing. Alternatively, a variation in thickness of the functional layer can be somewhat removed by bonding a second piece of glass using an index-matching adhesive. However, achieving improved TWD likely may employ much thicker flat glass, and a well-controlled adhesive process.

An alternative to a passive absorption filter may be to introduce an active electrically addressed filter. This can use an electro-optical device that can spatially attenuate light, such as a liquid-crystal based spatial-light-modulator (SLM) device. Such a device can be relatively low information content, and may not require high switching speed, or high contrast ratio, but a gray-level response may be beneficial. A device upstream of the PBS may be employed, provided that a polarized input is not needed. Polymer dispersed LC devices and electrophoretic display devices may operate without polarized input, but a scatter-mode device may likely degrade ANSI contrast.

Most LC devices may employ a polarized input. Since an XL system may recover light lost in polarizing the input, it may be unlikely that the modulator would be placed upstream of the PBS unless severe 2D attenuation was required. A modulator in one path may be capable of reducing the overall light level by more than approximately 50%, which may be adequate in many cases. The mechanism used for absorbing light in most cases is an analyzing polarizer. Since the OD may be high at the center, it may be beneficial to use a more heat-durable polarizer, such as a dye-stuff type polarizer or any appropriate polarizer. The dye-stuff type polarizers tend to have lower transmission than iodine type polarizers.

In an XL unit, a modulator can use the PBS as an input polarizer, either in the reflection or transmission path. The polarization efficiency from a wire-grid polarizer tends to be better in the P-path, specifically in the case in which modest OD may be beneficial, approximately <16 db attenuation, or 50:1, it may be sufficient to use the S-path. The fold-mirror may further reduce the OD. The modulator can be placed before the fold mirror, minimizing part size. Alternatively, the modulator can be part of the ZScreen assembly, taking advantage of existing highly flat end-cap glass. If a clean-up polarizer is used at the ZScreen, it may be used as the analyzer, though the specification may change. In the center, where OD can be high, the analyzer may absorb substantially all incident light. What can normally be accomplished with a high efficiency iodine polarizer, absorbing only approximately 2%, then may call for a polarizer that can handle significantly more light/heat. Changing to a high durability polarizer may have implications for 3D efficiency.

Continuing the discussion of employing an LC modulator as the filter, since an LC device can be driven to an all-pass state, it may remain in place for 3D operation. However, the insertion loss of the device, most notably the transparent electrode loss (ITO), can be significant. LC devices also tend to have a chromatic response.

Nematic LC devices may be the most achromatic for the voltage state in which the polarization is not substantially manipulated, such as where the molecules may be oriented substantially normal to the substrates. This may occur in either the low voltage, for example vertical alignment, or high voltage for example TN or ECB states. Maximizing 3D efficiency may make this the all-pass state, which may have the input/analyzing polarizers substantially parallel. However, the filtered state may then be relatively chromatic. An LC device with a more achromatic response, such as for example a thick TN device, may then be preferred, particularly since switching speed is of little to no consequence.

If the modulator can be physically removed during 3D operation, then efficiency may be improved, particularly if it also involves removing a high-durability polarization analyzer. Other incremental losses may include ITO, spacer scatter, substrate absorption, any fill-factor loss due to the addressing structure, and any residual polarization change associated with the all-pass state.

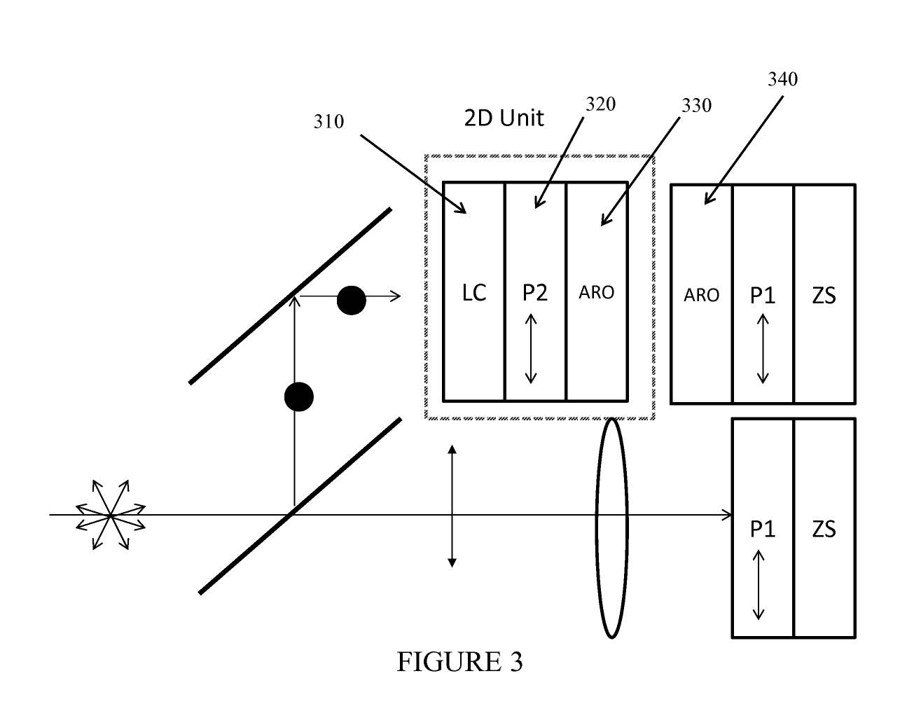

FIG. 3 is a schematic diagram illustrating one embodiment of an XL system with the filter. In one embodiment and as illustrated in FIG. 3, the XL embodiment may include an LC device 310, a high durability polarizer 320, and a 90-degree achromatic rotator 330, and can be slid into the S-path for 2D operation. The 90-degree achromatic rotator 330 may substantially cancel the effect of the second achromatic rotator, thus enabling a crossed-polarizer configuration for the modulator. The fully on-state may thus be chromatic, which may call for an adjustment in color balance which may be spatially dependent, but the off-state is relatively neutral.

In order to derive the optimum attenuation profile, the brightness at any screen point \vec{x}, can be written

B(\vec{o}, \vec{x})=L(\vec{x})*G(\vec{o}, \vec{x})*V(\vec{o},\vec{x})*A(\vec{x})

where L(\vec{x}) is the illuminance uniformity of the projector, I(\vec{x})is the geometric illuminance (cos(θ) contribution), G(\vec{o},\vec{x}) describes the screen gain properties, V(\vec{o}, \vec{x}) is the geometric luminance contribution (cos(θ′) contribution), A(\vec{x}) is the required attenuation factor, and \vec{o}is the observation location. L(\vec{x}) can either be measured for a specific projector, compiled from an ensemble of projector measurements or assumed from the DCI specification for illuminance uniformity. For simplicity, all calculations shown here will assume a center to corner fall-off of approximately 25% for L(\vec{x}). Note that the combination of I, G and V may be the BRDF function of the screen but we choose to separate the geometric contributions from the screen properties because the illuminance term may remain independent of viewing location. For all examples discussed hereafter, an approximate theater geometry is assumed including screen width 1, screen height 0.54, projector height 0.475 and throw 1.84, and a non-curved screen. Seating is “stadium type” with front left seat 0.33 away from the screen and 0.1 in from the left side. Rear left seat is 1.81 from the screen, aligned with the left edge and 0.29 above the bottom of the screen.

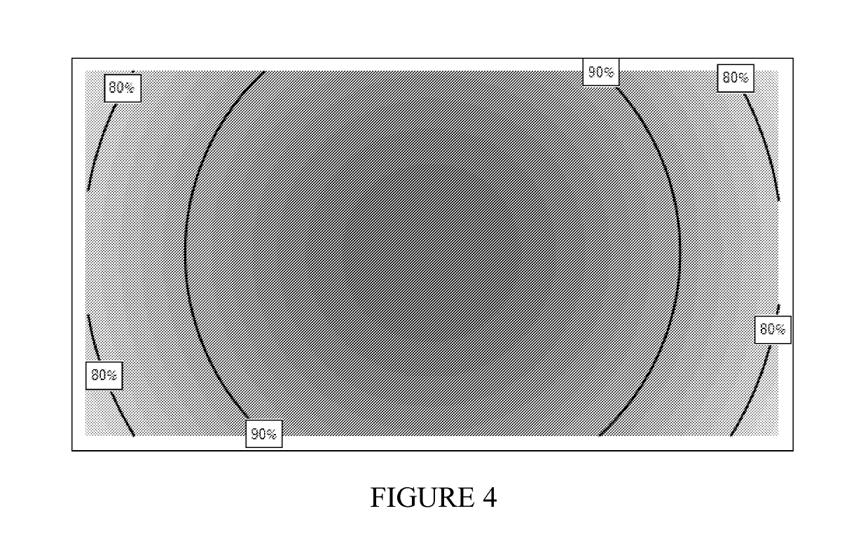

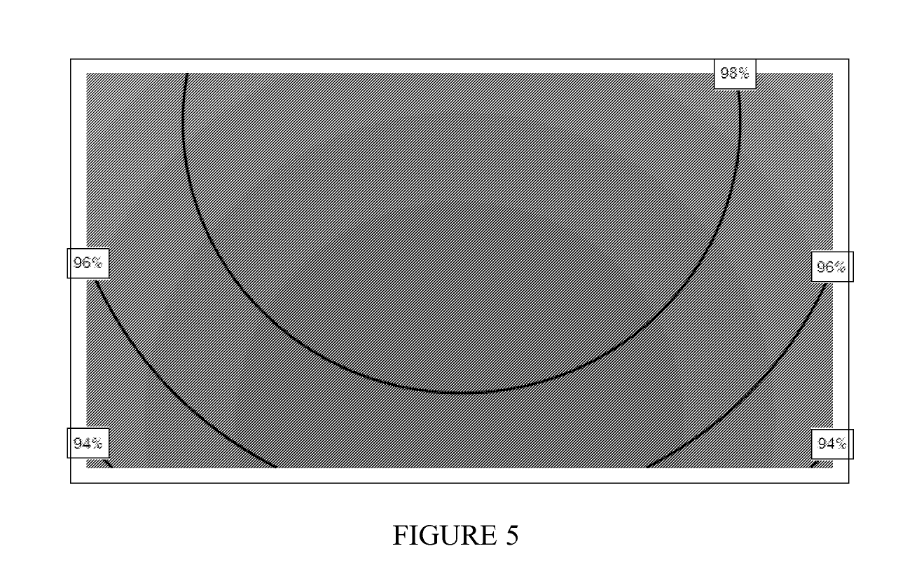

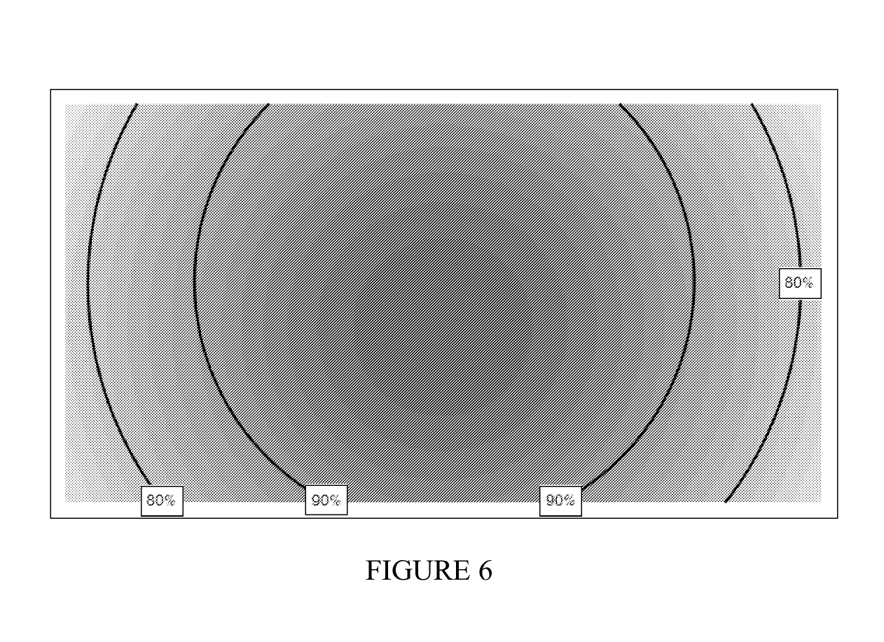

FIG. 4 is a schematic diagram illustrating one embodiment of a contour plot of an example DCI compliant projector illuminance uniformity. The DCI compliant projectors has an approximately 25% fall-off from center to edge. The brightest point is at the approximate center and contour lines indicate where the brightness has fallen to approximately 90% and 80% of the peak illuminance. FIG. 5 is a schematic diagram illustrating one embodiment of a geometric illuminance factor for an example theater geometry discussed above. Again, the system illustrated in FIG. 5 is a flat screen with typical theater geometry as previously discussed. FIG. 5 illustrates the cosine theta illuminance uniformity contribution. The bottom corners of the screen have the lowest illuminance because the incident angle onto the screen is largest at those points. FIG. 6 is a schematic diagram illustrating one embodiment of the combined effects of the two illuminance contributions, the projector illuminance uniformity contribution and the cosine theta illuminance uniformity contribution.

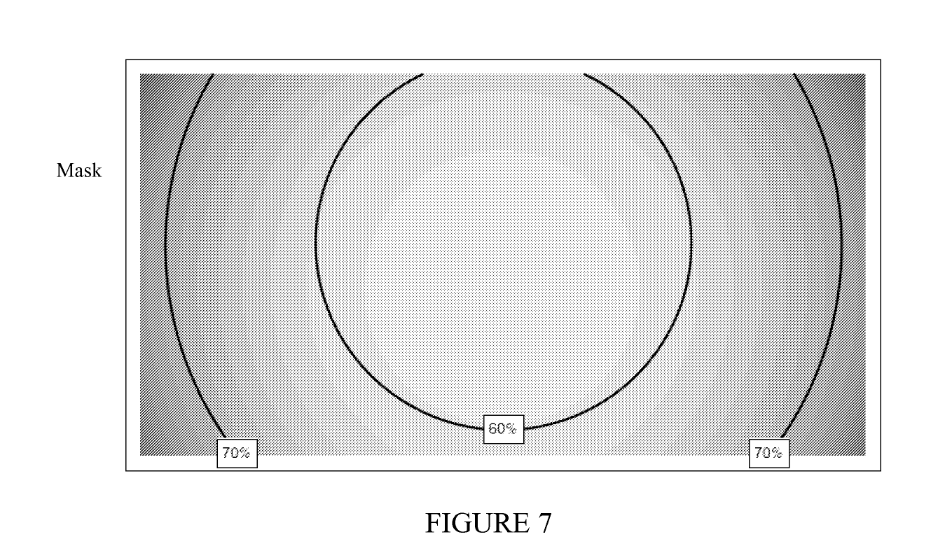

For the case of 3D brightness at approximately 7 fL with an efficiency of η=0.28, removal of the 3D system may result in a 2D brightness of approximately 25 fL. Consequently, the 2D image may be attenuated by approximately 43.7% in order to achieve the target of approximately 14 fL. FIG. 7 is a schematic diagram illustrating one embodiment of a contour plot of the transmissivity of a mask that corrects the illuminance factors for a flat screen with typical theater geometry. The mask has a transmission of approximately 56.5% at the center which then rises to a maximum of approximately 79.6% at the bottom corners. This mask may therefore result in a substantially uniform intensity on a Lambertian screen surface, neglecting the geometric effect of the observation location. In order to correct the brightness shading effect of the angle dependent gain, there may be an additional approximately 20.4% of transmission available in the corners. As such, the corners can be boosted by approximately 25%.

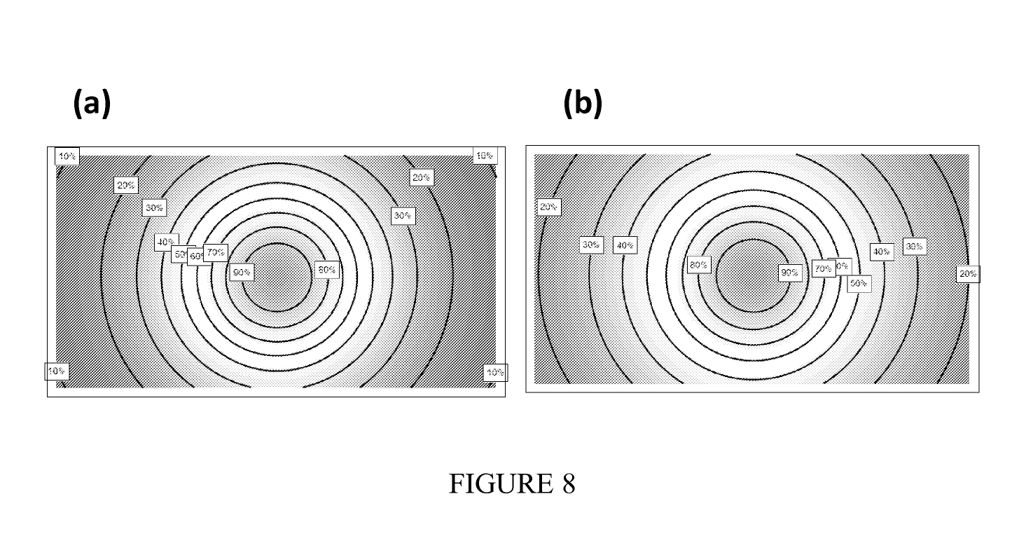

FIG. 8a is a schematic diagram illustrating one embodiment of a calculation of the uncorrected brightness distribution in an example theater. Further, FIG. 8a illustrates a calculation of the uncorrected brightness distribution in an example theater with a screen with HGA of approximately 22 degrees when viewed from the center seat in the auditorium which may be considered an “ideal” viewing location. The peak brightness occurs at the center of the screen at approximately 14 fL and the brightness falls to approximately 1.3 fL or 9% at the lower corners. In order to correct the image to substantially perfect uniformity, the center of the image may be attenuated by 91% while not attenuating the corners at all which is clearly impractical. If instead the center is attenuated by only about 43.7%, which may be approximately equivalent to 14 fL 2D and 7 fL 3D at η=0.28, and the attenuation decreases smoothly to approximately 0% at the corners, then the image uniformity can be significantly improved as shown in FIG. 8b. FIG. 8b is a schematic diagram illustrating one embodiment of a calculation of the corrected brightness distribution in the example theater. The brightness may be corrected by 43% for the 22 degree HGA screen. The center may remain at approximately 14 fL (14 fL for 2D and 7 fL for 3D), but the corners may only drop to approximately 2.2 fL or 16%.

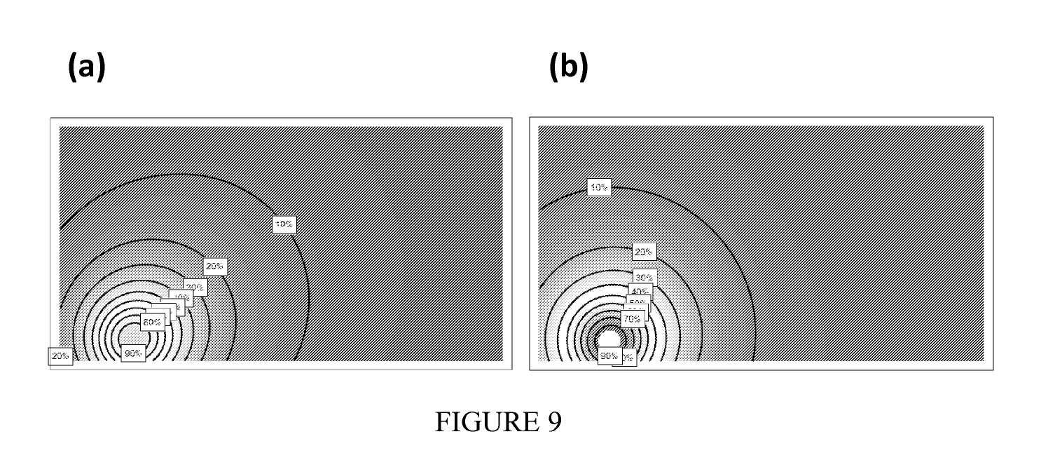

While the center seat calculation may be a reasonable proxy for the middle region of the auditorium, it may be useful to also consider the extreme viewing locations. The largest observation angles occur for the seats at the front corners of the auditorium. FIG. 9a is a schematic diagram illustrating one embodiment of the uncorrected brightness for the front left seat in an example auditorium. Further, FIG. 9a illustrates the uncorrected brightness for the front left seat in the example auditorium with a screen with HGA of 22 degrees. The peak brightness on this example screen is only 12 fL due to the fall-off from the two illuminance terms and the brightness falls to only 0.54 fL or 4.4% of this at the upper right corner of the screen.

FIG. 9b is a schematic diagram illustrating the same seat location as FIG. 9a with the attenuation mask employed in FIG. 8b. In this case the peak brightness on the example screen is 16.9 fL and it drops to only 0.85 fL or 5% at the edges. The brightness uniformity illustrates a negligible increase, but the total brightness of the image has been increased by over 40%. In some cases, there may be a trade-off between increase in uniformity and having some seats with brightness levels greater than the DCI specified maximum of 17 fL for theaters. The exhibitor may choose to apply less correction in order to maintain a ceiling of 17 fL for all seats and all screen locations. However, the DCI specification does not specifically address these extreme seating locations. It is likely that most exhibitors would deem the greater-than-17 fL measurements for a small minority of seats as a more than acceptable trade for greater brightness and uniformity for all seats. Alternatively, exhibitors may choose to increase the total attenuation of the filter such that the center seat receives less than 14 fL, but still more than the minimum of 11 fL, in order to keep the total brightness of all seats below some threshold. This would be especially useful on curved screens.

In extremely short-throw geometries, it may be useful to correct for the difference in path length through the absorbing layer due to incident angle. For example, in a theater with an approximate throw ratio of 0.8, if the center ray is normally incident on the absorber, then the corners may experience an increase in path length of approximately 8%, for index of refraction of 1.52 and thus an increase in absorption of over approximately 9%. Further, if the filter is tilted in order to substantially prevent reflections from re-entering the projection lens, then an additional correction may be provided due to the change in path length due to the tilt.

Embodiments of the present disclosure may be used in a variety of optical systems. The embodiment may include or work with a variety of projectors, projection systems, optical components, displays, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

It should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation. The various aspects of the present disclosure and the various features thereof may be applied together in any combination.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A method for balancing brightness in a projection system, comprising:
compensating for non-uniform luminance in a projection system by locating a filter in at least a first light path of the projection system by attenuating the luminance in at least a first operating mode of the projection system.

2. A method for balancing brightness in a projection system of claim 1, further comprising attenuating the greatest amount of luminance at a center region of the filter.

3. A method for balancing brightness in a projection system of claim 1, wherein attenuating the luminance further comprises attenuating primarily through absorption.

4. A method for balancing brightness in a projection system of claim 1, wherein the first operating mode is a 2D projection mode and a second mode of operation is a 3D projection mode.

5. A method for balancing brightness in a projection system of claim 1, wherein compensating for non-uniform luminance in a projection system further comprises, selecting and adjusting a spot size on the filter based primarily on tapering the luminance of the projection system.

6. A method for balancing brightness in a projection system of claim 1, further comprising removing the filter from the first light path when the projection system is in a second operating mode.

7. A method for balancing brightness in a projection system of claim 1, wherein attenuating the luminance further comprises, improving the brightness distribution on a screen of the projection system in the first operating mode.

8. A method for balancing brightness in a projection system of claim 1, further comprising switching the filter to allow substantially all the light to pass through the filter when the projection system is in a second operating mode.

9. A system for balancing brightness in a projection system, comprising:
a filter that compensates for non-uniform luminance in a projection system, wherein the filter is located in at least a first light path of a projection system in at least a first operating mode of the projection system, further wherein the filter attenuates the luminance in the at least first operating mode of the projection system.

10. A system for balancing brightness in a projection system of claim 9, wherein the filter further comprises a gradient neutral optical density filter.

11. A system for balancing brightness in a projection system of claim 9, wherein the filter is located in at least the first light path of the projection system in the at least first operating mode of the projection system and the filter is removed from the at least first light path of the projection system in a second operating mode of the projection system.

12. A system for balancing brightness in a projection system of claim 10, wherein the filter is coated with an antireflection material.

13. A system for balancing brightness in a projection system of claim 9, wherein the filter is roughly centered with respect to a projection lens of the projection system.

14. A system for balancing brightness in a projection system of claim 9, wherein the filter is tipped forward about the horizontal by the projector down-angle, such that the central ray of a projection lens may be approximately normally incident on the filter.

15. A system for balancing brightness in a projection system of claim 9, wherein the filter is switched electro-optically between a 2D operating mode and a 3D operating mode.

16. A system for balancing brightness in a projection system of claim 9, wherein the first operating mode of the projection system is a 2D projection mode and a second operating mode of the projection system is a 3D projection mode.

17. A system for balancing brightness in a projection system of claim 9, wherein the filter is an active electrically addressed filter.

18. A system for balancing brightness in a projection system of claim 9, wherein the filter is located on a movable mechanism that removes the filter from the light path.

19. A system for balancing brightness in a projection system of claim 9, wherein the filter is a passive filter.

20. A system for balancing brightness in a projection system of claim 9, wherein the filter is the least transmissive at the center and more transmissive with increasing distance from the center of the filter.

21. An optical system for balancing the brightness of a projection system, comprising:
a filter that increases light transmission with increasing distance relative to the center of the filter in a first mode and that substantially maintains transmitted peak brightness in a second mode.
